(19) United States
(12) Patent Application Publication
(10) Pub. No.: US 2015/0004709 A1
(43) Pub. Date: Jan. 1, 2015

(54) Methods for Identification of Materials Causing Corrosion on Metallic Substrates within ZPGM Catalyst Systems

(71) Applicant: Zahra Nazarpoor, Camarillo, CA (US)

(72) Inventor: Zahra Nazarpoor, Camarillo, CA (US)

(73) Assignee: CDTI, Ventura, CA (US)

(21) Appl. No.: 13/927,940

(22) Filed: Jun. 26, 2013

(51) Int. Cl. G01N 17/00

(52) U.S. Cl. CPC G01N 17/006
USPC 436/37

(57) ABSTRACT

The present disclosure provides an identification process which may employ various identification techniques on Zero platinum group metal (ZPGM) catalyst systems, in order to identify responsible materials for the formation of corrosion material, such as hexavalent chromium compounds. Identification analysis, such as X-ray diffraction analysis (XRD), X-ray fluorescence (XRF), and X-ray Photoelectron Spectroscopy (XPS) may be performed on various thermally treated ZPGM catalyst systems, such as in bare substrate, substrate with one type of ZPGM in washcoat, a substrate with one type of ZPGM in overcoat and substrate combination of ZPGM metals in both washcoat and overcoat. Results of identification analysis may show that regardless of metal catalyst (for example Ag, Cu, Ce), hexavalent chromium (Cr⁶⁺) may be formed on aged catalysts systems, which may be due to the high concentration of chromium in substrate. Therefore, corrosion and production of hexavalent chromium may initiate from elements found in the substrate and not from elements within the ZPGM metal catalysts.

### CROSS-REFERENCE TO RELATED APPLICATIONS

N/A

### BACKGROUND

1. Technical Field

The present disclosure relates generally to ZPGM catalyst systems, and, more particularly, to identification of corrosion causes on ZPGM catalyst systems.

2. Background Information

Catalyst in catalytic converters may be manufactured to decrease pollution caused by exhaust gases from automobiles, utility plants, processing and manufacturing plants, trains, airplanes, mining equipment and other engine-equipped machinery. A major problem with manufacturing of catalyst systems may be the presence of corrosion on catalyst systems. Formulations of catalysts systems may include at least a substrate, a washcoat and an overcoat.

In catalyst systems with some application such as motorcycle, metallic catalyst support structures or substrates may be preferred over inorganic (e.g., ceramic) catalyst substrates. There may be many alloys employed as substrates for catalyst systems, which may include corrosive metals such as iron, chromium and among others. Additionally, washcoat and overcoat, within catalyst systems, may include elements that may also contribute in the formation of corrosion.

There is therefore a need for methods for identifying materials within substrates, washcoats or overcoats of catalyst systems that may contribute in the formation of corrosion, in order to avoid using such materials in the manufacturing of catalyst systems, and therefore allowing a better performance of the catalyst systems.

### SUMMARY

The present disclosure may provide an identification process in which a plurality of identification analysis may be performed to detect material compositions that may be responsible for the formation of corrosion in zero platinum group metal (ZPGM) catalyst systems. Current techniques to be used in the identification analysis, as known in the art, may include, but are not limited to, X-ray diffraction analysis (XRD), X-Ray Fluorescence (XRF), and X-ray Photoelectron Spectroscopy (XPS).

According to embodiments in present disclosure, compositions of ZPGM catalyst systems may include any suitable combination of a metallic substrate, a washcoat, and an overcoat . Washcoat, and/or an overcoat may include ZPGM metal catalyst such as copper (Cu), cerium (Ce), silver (Ag), and other metal combinations. Catalyst samples with metallic substrate of varied geometry and cells per square inch (CPSI) may be prepared using any suitable synthesis method as known in current art.

Materials compositions, such as hexavalent chromium compounds may be identified in a variety of zero platinum group metal (ZPGM) catalysts which may be prepared according to different configurations that may include a bare metallic substrate only, a washcoat on a metallic substrate, an overcoat on a metallic substrate, or a washcoat and overcoat on a metallic substrate.

According to embodiments in the present disclosure, the identification analysis may show that regardless of the transition metal catalyst, which may include silver, copper, other transition metal or combinations thereof, in the formulations of the samples that may be prepared, hexavalent chromium may be formed after aging different types of ZPGM catalyst systems for about 4 hours at about 900° C. under dry condition. Additionally, the identification process in the present disclosure, when applied to configurations including only WC, only OC, and both washcoat and overcoat on a metallic substrate may be able to identify hexavalent chromium or other toxic components which may be due to the high concentration of chromium in the metallic substrate.

Additionally, the XRD, XRF, and XPS identification analysis may additionally show that corrosion materials detected and production of hexavalent chromium may come from elements found in the metallic substrate and not from elements materials composition within the metal catalysts. The identification process may help manufacturers of catalyst systems to use suitable materials, and thus formulate catalyst systems with enhanced catalytic performance and that, when undergone through a thermal treatment, may not produce hexavalent chromium.

Numerous other aspects, features, and advantages of the present disclosure may be made apparent from the following detailed description.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 illustrates a ZPGM catalyst system, referred to “Type 1 ZPGM catalyst system”, according to an embodiment.

FIG. 2 illustrates a ZPGM catalyst system, referred to “Type 2 ZPGM catalyst system”, according to an embodiment.

FIG. 3 illustrates a ZPGM catalyst system, referred to “Type 3 ZPGM catalyst system”, according to an embodiment.

FIG. 4 illustrates a ZPGM catalyst system, referred to “Type 4 ZPGM catalyst system”, according to an embodiment.

FIG. 5 shows X-ray diffraction (XRD) patterns for aged Type 2 ZPGM catalyst system, according to an embodiment.

FIG. 6 presents XRF analysis for Type 2 ZPGM catalyst system, according to an embodiment.

FIG. 7 shows X-ray diffraction (XRD) patterns for aged Type 3 ZPGM catalyst system, according to an embodiment.

FIG. 8 presents X-ray photoelectron spectroscopy (XPS) analysis of Cr2p for Type 3 ZPGM catalyst system, according to an embodiment.

FIG. 9 presents X-ray photoelectron spectroscopy (XPS) analysis of Cu2p for Type 3 ZPGM catalyst system, according to an embodiment.

FIG. 10 shows X-ray diffraction (XRD) patterns for aged Type 4 ZPGM catalyst system, according to an embodiment.

FIG. 11 presents X-Ray Fluorescence (XRF) analysis for aged Type 4 ZPGM catalyst system, according to an embodiment.

FIG. 12 presents X-ray photoelectron spectroscopy (XPS) analysis of Cr2p Type 4 for ZPGM catalyst system, according to an embodiment.

FIG. 13 presents X-ray photoelectron spectroscopy (XPS) analysis of Ag3d for Type 4 ZPGM catalyst system, according to an embodiment.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

### Definitions

As used here, the following terms may have the following definitions:

“Catalyst system” may refer to a system of at least two layers including at least one substrate, a washcoat, and/or an overcoat.

“Substrate” may refer to any material of any shape or configuration that yields a sufficient surface area for depositing a washcoat and/or overcoat.

“Washcoat” may refer to at least one coating including at least one oxide solid that may be deposited on a substrate.

“Overcoat” may refer to at least one coating that may be deposited on at least one washcoat layer.

“Catalyst” may refer to one or more materials that may be of use in the conversion of one or more other materials.

“Zero platinum group (ZPGM) catalyst” may refer to a catalyst completely or substantially free of platinum group metals.

“Platinum group metals” may refer to, platinum, palladium, ruthenium, iridium, osmium, and rhodium.

“Carrier material oxide” may refer to materials used for providing a surface for at least one catalyst.

“Oxygen storage material (OSM)” may refer to a material able to take up oxygen from oxygen rich streams and able to release oxygen to oxygen deficient streams.

“Treating,” “treated,” or “treatment” may refer to drying, firing, heating, evaporating, calcining, or mixtures thereof.

“X-ray diffraction” or “XRD Analysis” may refer to a rapid analytical technique that investigates crystalline material structure, including atomic arrangement, crystalline size, and imperfections in order to identify unknown crystalline materials (e.g. minerals, inorganic compounds).

“X-ray fluorescence spectrometry” or “XRF Analysis” may refer to a spectrometric analysis that based on the principle that individual atoms, when excited by an external energy source, emit X-ray photons of a characteristic energy or wavelength, in order to identify and quantify the elements present within a sample.

“X-ray Photoelectron Spectroscopy” or “XPS Analysis” may refer to a surface analysis technique in which the sample may be irradiated with mono-energetic x-rays causing photoelectrons to be emitted from the sample surface. An electron energy analyzer may determine the binding energy of the photoelectrons. From the binding energy and intensity of a photoelectron peak, the elemental identity, chemical state, and quantity of an element are determined.

“Edge” may refer to the connection of substrate lip and substrate matrix within catalyst systems.

### DESCRIPTION OF THE DRAWINGS

Various example embodiments of the present disclosure are described more fully with reference to the accompanying drawings in which some example embodiments of the present disclosure are shown. Illustrative embodiments of the present disclosure are disclosed here. However, specific structural and functional details disclosed here are merely representative for purposes of describing example embodiments of the present disclosure. This disclosure however, may be embodied in many alternate forms and should not be construed as limited to only the embodiments set forth in the present disclosure.

Zero platinum group metal (ZPGM) catalyst systems may be prepared in order to observe possible formation of corrosion material and perform qualitative and quantitative analysis to identify elements and compounds within catalyst systems that may contribute in the formation of corrosion material and hexavalent chromium.

Preparation of ZPGM Catalyst Systems

A ZPGM catalyst system including a metallic substrate, a washcoat (WC) and an overcoat (OC) may be prepared. Metallic substrate may be used with varied substrates geometry and cells per square inch (CPSI).

According to an embodiment of the present disclosure, washcoat may include at least one ZPGM transition metal catalyst and a carrier material oxide. ZPGM transition metal catalyst may include scandium, manganese, iron, cobalt, nickel, copper, zinc, yttrium, niobium, molybdenum, silver, cadmium, tantalum, tungsten, and gallium. Most suitable ZPGM transition metal may be silver. The total amount of silver may be of about 1% w/w to about 20% w/w of the total catalyst weight; most suitable amount may be of about 5% w/w to 8% w/w. Carrier material oxide, within washcoat, may include alumina (Al₂O₃) or lanthanum doped alumina. Carrier material oxides may be present in washcoat in a ratio between about 40% w/w to about 60% w/w.

Overcoat may include at least one ZPGM transition metal such as copper oxide, ceria, at least one carrier material oxides, and at least one oxygen storage material (OSM), which may be a mixture of cerium (Ce), zirconium (Zr), neodymium (Nd), and praseodymium (Pr). The copper (Cu) and Ce in overcoat may be present in about 5% w/w to about 50% w/w or from about 10% w/w to about 16% w/w of Cu; and about 12% w/w to about 20% w/w of Ce. Carrier material oxides, within overcoat, may include aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof. Suitable carrier material oxide for the disclosed overcoat may include one or more selected from the group consisting of aluminum oxide (Al₂O₃) or doped aluminum oxide. The doped aluminum oxide in overcoat may include one or more selected from the group consisting of lanthanum, yttrium, lanthanides and mixtures thereof. The amount of doped lanthanum in alumina may vary from 0% w/w (i.e., pure aluminum oxide) to 10% w/w of lanthanum oxide. Other embodiments may include pure alumina (Al₂O₃) as Carrier material oxides. Carrier material oxides and OSM included in overcoat may be present in a ratio of about 60% w/w to about 40% w/w.

Disclosed ZPGM catalyst systems may be prepared employing co-milling, co-precipitation or other suitable preparation technique known in the art. After deposition, washcoat and overcoat may be thermally treated. This thermal treatment (aging) may be performed at about 300° C. to about 1100° C. In some embodiments, a thermal treatment may be performed heating catalyst systems to temperatures of about 900° C. The heat treatment may last from about 2 hours to about 6 hours. Most suitable thermal treatment may last about 4 hours. The WC and OC loading may vary from about 60 g/L to about 200 g/L, separately.

The following types of ZPGM catalysts systems may be prepared for identification analysis tests:

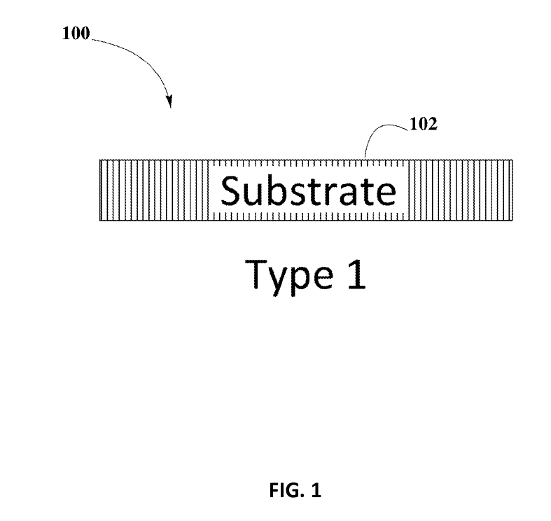

FIG. 1 illustrates a ZPGM catalyst system, referred to Type 1 ZPGM catalyst system 100; where Type 1 ZPGM catalyst system 100 may include bare metallic substrate 102. According to an embodiment, bare metallic substrate 102 may include about 17% w/w to about 19% w/w of chromium (Cr), less than about 0.6% w/w of nickel (Ni), about 0.9% w/w to about 1.5% w/w of molybdenum (Mo), less than about 1% w/w of silicon (Si), less than about 1% w/w of manganese (Mn), and balance of iron (Fe). Metallic substrate 102 may be used with different dimensions and cell densities. In an embodiment, substrate 102 may be 40 mm×60 mm, 300 cells per square inch (CPSI).

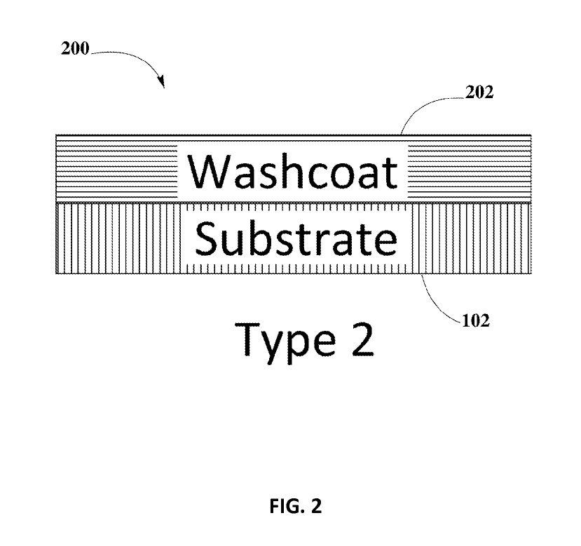

FIG. 2 illustrates a ZPGM catalyst system, referred to Type 2 ZPGM catalyst system 200; where Type 2 ZPGM catalyst system 200 may include washcoat 202 on metallic substrate 102. Washcoat 202 may be prepared using co-milling. In one embodiment, washcoat 202 may include a carrier material oxide and a ZPGM transition metal catalyst.

According to an embodiment, ZPGM transition metal may be silver. The total amount of silver may be of about 1% w/w to about 20% w/w of the total catalyst weight; most suitable amount of silver may be of about 5% w/w to about 8% w/w. Different silver salts such as nitrate, acetate or chloride may be used as ZPGM catalysts precursor.

According to an embodiment, carrier material oxides within disclosed washcoat 202 may be pure alumina (Al₂O₃). Carrier material oxide may be present in washcoat 202 in amounts of about 40% w/w to about 60% w/w.

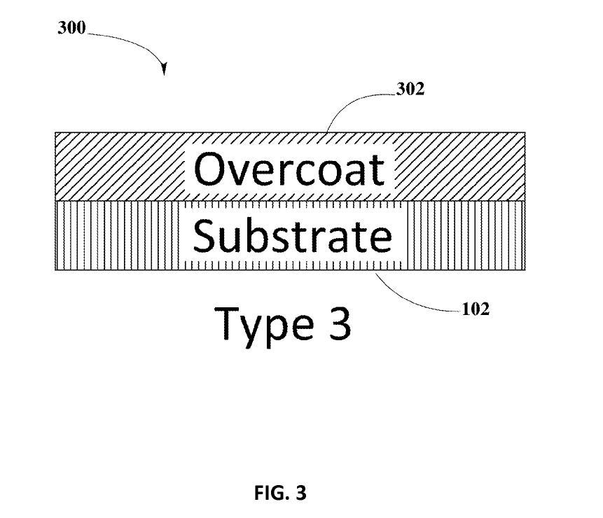

FIG. 3 illustrates a ZPGM catalyst system, referred to Type 3 ZPGM catalyst system 300; where Type 3 ZPGM catalyst system 300 may include overcoat 302 on metallic substrate 102. Overcoat 302 may be prepared using co-precipitation methods. Overcoat 302 may include ZPGM transition metal catalysts that may include one or more ZPGM transition metals, and least one rare earth metal, or mixture thereof that are completely free of platinum group metals. According to an embodiment, ZPGM transition metal catalyst within the disclosed overcoat 302 may be Cu and rare earth metal within disclosed overcoat 302 may be Ce. The total amount of copper catalyst included in overcoat 302 may be of about 5% w/w to about 50% w/w of the total catalyst weight, most suitable amount of may be of about 10% w/w to 16% w/w. Furthermore, the total amount of cerium catalyst included in overcoat 302 may be of about 5% w/w to about 50% w/w of the total catalyst weight, most suitable amount may be of about 12% w/w to about 20% w/w. Different copper as well as cerium salts such as nitrate, acetate or chloride may be used as catalysts precursors.

Additionally, overcoat 302 may include carrier material oxides. According to an embodiment, carrier material oxides within overcoat 302 may be lanthanum doped alumina (about 4% w/w lanthanum). Carrier material oxide may be present in overcoat 302 in amounts of about 40% w/w to about 60% w/w.

Furthermore, overcoat 302 may also include OSM. Amount of OSM may be of about 10% w/w to about 90% w/w, most suitable of about 40% w/w to about 75% w/w. The OSM may include at least one oxide selected from the group consisting of cerium, zirconium, lanthanum, yttrium, lanthanides, actinides, and mixtures thereof. OSM in the present overcoat 302 may be a mixture of ceria and zirconia; more suitable, a mixture of (1) ceria, zirconia, and lanthanum or (2) ceria, zirconia, neodymium, and praseodymium, and most suitable, a mixture of cerium, zirconium, and neodymium.

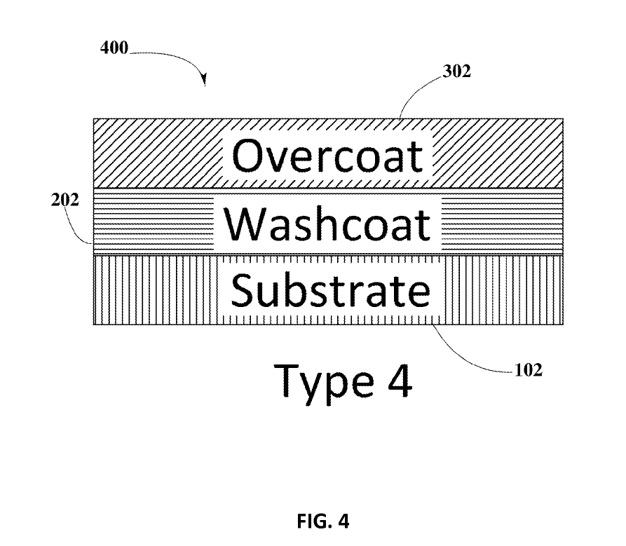

FIG. 4 illustrates a ZPGM catalyst system, referred to Type 4 ZPGM catalyst system 400; where Type 4 ZPGM catalyst system 400 may include washcoat 202 and overcoat 302 on metallic substrate 102. Washcoat 202 may be prepared using co-milling process. Furthermore, the milled washcoat 202, in the form of aqueous slurry may be deposited on substrate 102 and washcoat 202 may be treated. Subsequently, overcoat 302, which may be prepared by co-precipitation process, may be deposited on washcoat 202.

According to an embodiment, washcoat 202 within Type 4 ZPGM catalyst system 400 may include composition of Type 2 ZPGM catalyst system 200. Similarly, overcoat 302 within Type 4 ZPGM catalyst system 400 may include composition of Type 3 ZPGM catalyst system 300.

All types of catalysts systems disclosed, may be thermally treated at 550° C. for about 4 hours, followed by dry aging at 900° C. for about 4 hours. After aging, a yellow-orange color on the surface of Type 1 ZPGM catalyst system 100 may be observed, a red color on the surface of substrate 102 edge of Type 2 ZPGM catalyst system 200 may be observed, a yellow-green color on the surface of substrate 102 edge of Type 3 ZPGM catalyst system 300 may be observed, and a red-orange color on the surface of substrate 102 edge of Type 4 ZPGM catalyst system 400 may be observed.

In order to identify element or compound causing color change or possible corrosion on catalyst systems, samples for Type 1 ZPGM catalyst system 100, Type 2 ZPGM catalyst system 200, Type 3 ZPGM catalyst system 300, and Type 4 ZPGM catalyst system 400 were analyzed employing identification analysis, such as X-ray diffraction analysis (XRD), X-ray fluorescence (XRF), and X-ray Photoelectron Spectroscopy (XPS).

Identification Analysis

Colored areas (corrosion) within previously described types of catalyst systems may be peeled off from the surface of the catalyst system and may be grind into powder form. Corrosion powder samples of catalyst systems may be analyzed on XRD, XRF, and XPS equipment, in order to identify compounds and elements that may be responsible for the corrosion observed on disclosed catalysts systems and therefore determine whether the metallic substrate 102 or the ZPGM catalysts may influence in the production of such color change or corrosion.

XRF analysis of fresh Type 1 ZPGM catalyst system 100, shows different alloy composition of substrate 102 matrix and substrate 102 skin. The matrix composition of Type 1 ZPGM catalyst system 100 may include about 20.35% w/w of Cr, about 61.29% w/w of Fe, and about 18.36% w/w of Ni. Additionally, XRF analysis may be performed on inside the substrate 102 matrix of fresh samples of Type 1 ZPGM catalyst system 100, which may show that alloy composition may include about 17% w/w of Cr, and about 82% w/w of Fe.

Moreover, XRF analysis may also be performed on corrosion part of the substrate 102 skin after aging of Type 1 ZPGM catalyst system 100 samples. XRF analysis for skin corrosion aged Type 1 ZPGM catalyst system 100 may show the composition containing about 30% w/w of Cr, and about 70% w/w of Fe.

Therefore, XRF analysis may show that Type 1 ZPGM catalyst system 100, after being aged, may include a corrosive material that may not only include Fe, but also Cr, which may be in the form of chromium (III) oxide (Cr₂O₃) and may be liberated from metal alloy, within substrate 102 matrix, to the skin surface of Type 1 ZPGM catalyst system 100. The presence of Fe₂O₃ and Cr oxide may produce a yellow-orange color on the surface of Type 1 ZPGM catalyst system 100.

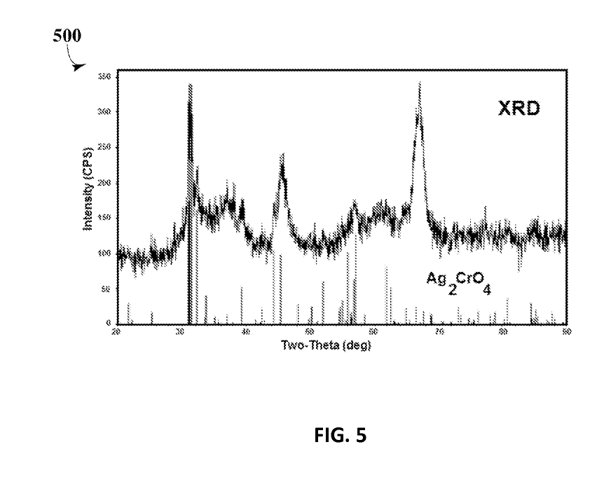

FIG. 5 shows X-ray diffraction (XRD) patterns 500 for aged Type 2 ZPGM catalyst system 200, where taken from the reddish material formed on substrate 102 internal edge. The main XRD diffraction peaks (signal) may be consistent with diffraction peaks of silver chromate (Ag₂CrO₄) compound (pdf #01-072-0858); thus showing that Ag₂CrO₄ (with hexavalent chromium) may be present on corrosion material within Type 2 ZPGM catalyst system 200. Other compounds, such as silver oxide, may be analyzed, by matching reference pdf for such compounds; therefore formation of silver oxide may be discarded.

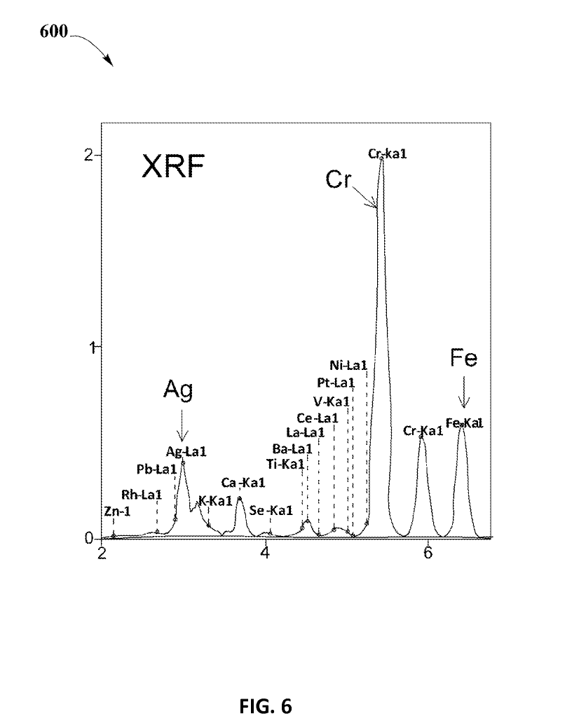

FIG. 6 presents XRF analysis 600 for reddish material formed on substrate 102 internal edge of Type 2 ZPGM catalyst system 200, after aging. XRF analysis may show that the most intense signals belongs to Ag, Fe and high concentrations of Cr, in which Cr and Fe liberates from metallic substrate 102 and Ag from washcoat 202 materials.

Therefore, XRF analysis 600 may show that Type 2 ZPGM catalyst system 200, after being aged, may include a corrosive material that may not only include Fe, but also Cr, which may be in the form of Ag₂CrO₄ Type 2 ZPGM catalyst system 200. Formation of Ag₂CrO₄ may produce a red color on the surface of Type 2 ZPGM catalyst system 200.

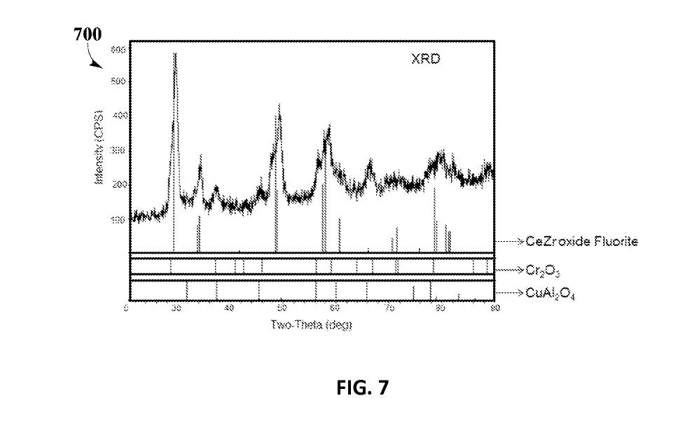

FIG. 7 shows X-ray diffraction (XRD) patterns 700 for yellow-greenish material formed on substrate 102 internal edge of aged Type 3 ZPGM catalyst system 300. The main XRD diffraction peaks (signal) may be consistent with diffraction peaks of cerium zirconium oxide fluorite (Ce_{0.5}Zr_{0.5}O₂) (pdf #00-055-0997), copper aluminate spinel (CuAl₂O₄) (pdf #01-078-1605), and chromium oxide (Cr₂O₃) (pdf #00-009-0332b). Identified Cr₂O₃ may come from substrate 102, moreover identified Ce_{0.5}Zr_{0.5}O₂ and CuAl₂O₄ may come from overcoat 302. Other compounds; such as copper chromate or any other hexavalent chromate, may be analyzed, but overlapped with stronger diffraction peaks of other compounds, therefore formation of hexavalent chromate may be confirmed by XPS.

Additionally, XRF analysis may be performed on samples of aged Type 3 ZPGM catalyst system 300. XRF analysis for aged Type 3 ZPGM catalyst system 300 samples may show that Type 3 ZPGM catalyst system 300 may include Cu, Ce, Zr, Fe and Cr.

Therefore, XRF analysis may show that Type 3 ZPGM catalyst system 300, after being aged, may include a corrosive material that may include Cu, Ce, Zr, Fe and Cr, which that may be liberated from metal alloy, within substrate 102, to the skin surface of Type 2 ZPGM catalyst system 200.

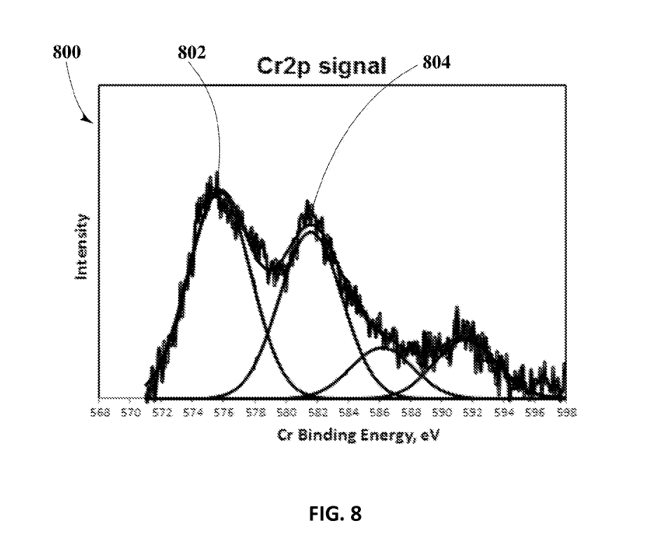

FIG. 8 presents X-ray photoelectron spectroscopy (XPS) analysis 800 for yellow-greenish material formed on substrate 102 internal edge of aged Type 3 ZPGM catalyst system 300. Results of chromium binding energy, as shown in Cr2p signal graph, may show the presence of about 55% w/w of Cr₂O₃, trivalent chromium (3⁺) Cr3+ 802, which has a binding energy in the range of about 575 eV to about 578 eV; and about 45% w/w of hexavalent chromium Cr6+ 804, which has a binding energy in the range of about 578 eV to about 584 eV. Trivalent chromium may come from the formation of Cr₂O₃ which may come from substrate 102 and was detected by XRD results as well.

In order to identify compounds including hexavalent chromium that may be present in Type 3 ZPGM catalyst system 300, an XPS analysis may be performed for copper binding energy, as shown in Cu2+ signal graph on samples of aged Type 3 ZPGM catalyst system 300.

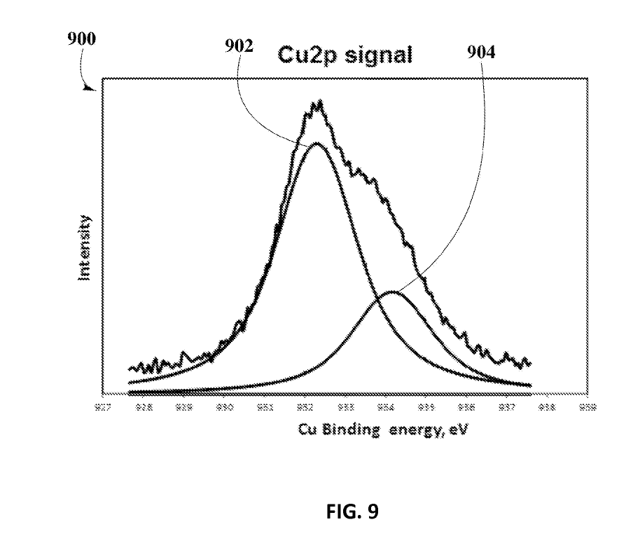

FIG. 9 presents X-ray photoelectron spectroscopy (XPS) analysis 900 for yellow-greenish material formed on substrate 102 internal edge of aged Type 3 ZPGM catalyst system 300. Results of copper binding energy, as shown in copper 2p signal graph, may show the presence of about 70% w/w of monovalent copper Cu1+ 902, which has a binding energy range of about 932 eV to 932.5 eV, and about 30% w/w of divalent copper Cu2+ 904 which may have a binding energy range of about 933.5 eV to about 935 eV. Cu2+ 904 may come from copper aluminate that may come from overcoat 302 and detected by XRD results as shown in FIG. 7. Moreover, Cu1+ 902 may have reacted with chromate and may produce copper dichromate Cu₂(Cr₂O₇) (with hexavalent chromium), which may provide a yellow-green color that may be observed on the surface of Type 3 ZPGM catalyst system 300. The presence of hexavalent chromate is confirmed in FIG. 8.

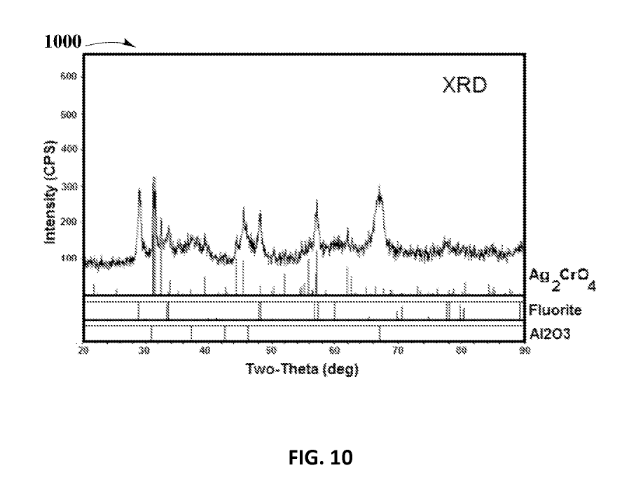

FIG. 10 shows X-ray diffraction (XRD) patterns 1000 for red-orangish material formed on substrate 102 internal edge of aged Type 4 ZPGM catalyst system 400. The main XRD diffraction peaks (signal) may be consistent with diffraction peaks of Ag₂CrO₄ (pdf #01-072-0858), Ce_{0.5}Zr_{0.5}O₂ (fluorite) (pdf #00-055-0997), and alumina (Al₂O₃) (pdf #00-013-0373); thus showing that Ag₂CrO₄ (hexavalent chromium), Ce_{0.5}Zr_{0.5}O₂, and Al₂O₃ may be present on corrosion material of Type 4 ZPGM catalyst system 400. However, fluorite and alumina contains in overcoat 302 material and silver contains in washcoat 202 material and chromium may provide by substrate 102 alloy.

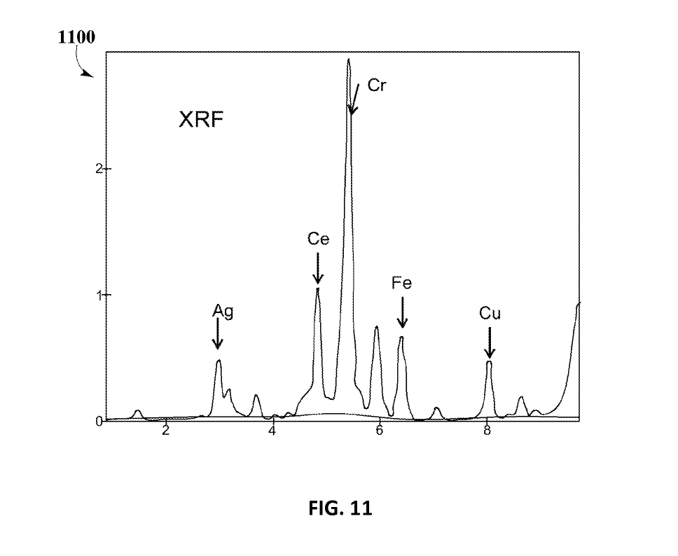

FIG. 11 presents X-Ray Fluorescence (XRF) analysis 1100 for red-orangish material formed on substrate 102 internal edge of aged aged Type 4 ZPGM catalyst system 400. XRF analysis may show that the most intense peaks detected for Ag, Cu, Ce, Fe and high concentrations of Cr. The presence of Ag caused by washcoat 202 materials and the contents of Cu, Ce caused by overcoat 302 materials while Fe and Cr contents are detection of substrate 102 alloys materials which liberates from substrate 102 after aging. X-Ray Fluorescence (XRF) analysis 1100 results are consistent.

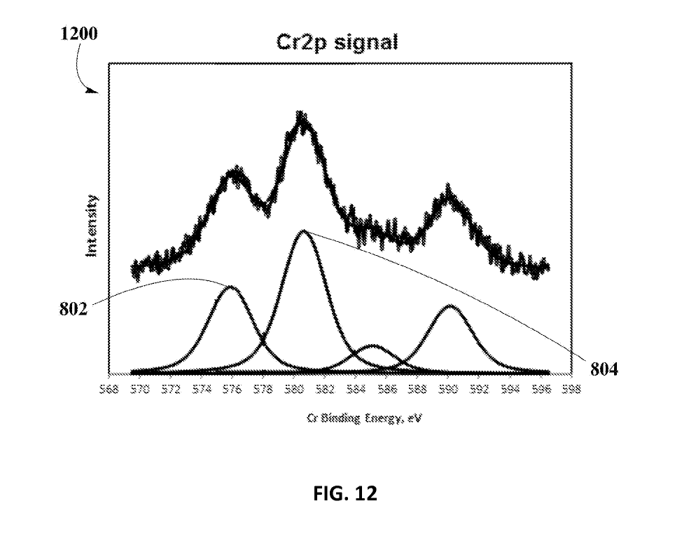

FIG. 12 presents X-ray photoelectron spectroscopy (XPS) analysis 1200 for red-orangish material formed on substrate 102 internal edge of aged aged Type 4 ZPGM catalyst system 400. Results of chromium binding energy, as shown in Cr2p signal graph, may show the presence of about 40% w/w of Cr₂O₃, trivalent chromium Cr3+ 802, which has a binding energy in the range of about 575 eV to about 578 eV; and about 60% w/w of Cr6+ 804, which has a binding energy in the range of about 578 eV to about 584 eV. Cr3+ 802 may come from the formation of Cr₂O₃ which may come from substrate 102. The presence of Cr6+ 804 may correspond to formation of sliver chromate which observed by XRD results of FIG. 10.

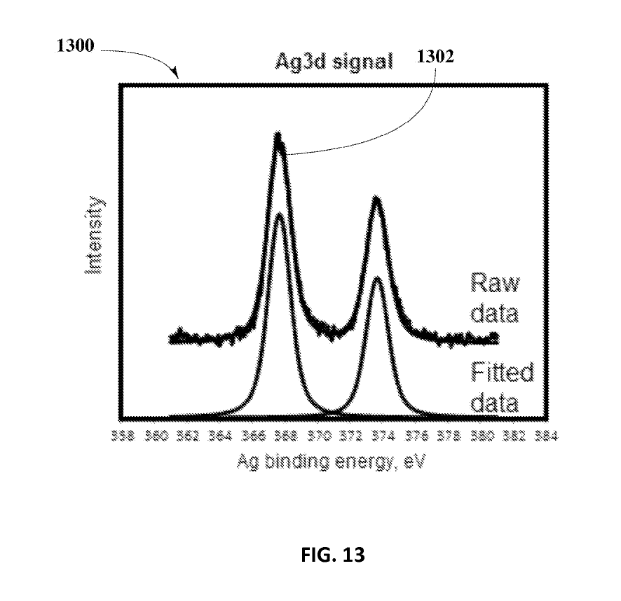

FIG. 13 presents X-ray photoelectron spectroscopy (XPS) analysis 1300 for red-orangish material formed on substrate 102 internal edge of aged Type 4 ZPGM catalyst system 400. Results of silver binding energy, as shown in Ag3d signal graph, may show the presence of monovalent silver Ag1+ 1302, which may have binding energy in ranges of about 367.3 eV to about 367.8 eV. Ag1+ 1302 may come from washcoat 202 and may react with Cr oxide and form Ag₂CrO₄.

Therefore, regardless of ZPGM metal catalyst (for example Ag, Cu, Ce), Cr6+ 804 may be formed after aging Type 2 ZPGM catalyst system 200, Type 3 ZPGM catalyst system 300, and Type 4 ZPGM catalyst system 400 at 900° C., which may be due to the high concentration of chromium in substrate 102.

The XRD, XRF, and XPS identification analysis performed on the 3 types of ZPGM catalyst systems of the present disclosure, show that corrosion and production of hexavalent chormium may be initiated from elements found in substrate 102 and not from elements within metal catalysts used. This identification may help catalyst systems manufacturers to formulate catalyst systems that may not produce hexavalent chromium compounds, such as chromate salts or chromic acid, which may produce corrosion or which may be released as toxic vapors.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A method for detecting corrosion in a catalytic system, comprising:
aging at least one catalyst system in communication with a substrate;
determining at least one color change on a surface of the at least one catalyst system, wherein the surface of the at least one catalyst system comprises a zero platinum group metal catalyst,
analyzing at least one portion of the surface using a method selected from the group consisting of X-ray diffraction analysis (XRD), X-Ray Fluorescence (XRF), X-ray Photoelectron Spectroscopy (XPS), and combinations thereof;
wherein at least one corrosive material is identified in the at least one catalyst system according to said analyzing.

2. The method according to claim 1, wherein the aging comprises heating to about 900° C.

3. The method according to claim 1, wherein the aging comprises heating for about 4 hours.

4. The method according to claim 1, wherein the aging is performed under dry conditions.

5. The method according to claim 1, wherein the catalyst system comprises one selected from the group consisting of a washcoat, an overcoat, and combinations thereof.

6. The method according to claim 1, wherein the zero platinum group metal catalyst comprises one selected from the group consisting of copper, cerium, silver, and combinations thereof.

7. The method according to claim 1, wherein hexavalent chromium is identified in the catalyst system.

8. The method according to claim 7, wherein the hexevalent chromium is Ag₂CrO₄.

9. The method according to claim 7, wherein the hexevalent chromium is Cu₂(Cr₂O₇).

10. The method according to claim 1, wherein the at least one color change comprises green.

11. The method according to claim 1, wherein the at least one color change comprises orange.

12. The method according to claim 1, wherein the at least one color change comprises red-orange.

13. The method according to claim 1, wherein the at least one color change comprises green-yellow.

14. The method according to claim 1, wherein the at least one color change occurs proximate to an edge of the catalyst system.

15. The method according to claim 1, wherein the at least one corrosive material comprises cerium zirconium oxide fluorite.

16. The method according to claim 1, wherein the at least one corrosive material comprises copper aluminate spinel.
